(19) United States
(12) Patent Application Publication
(10) Pub. No.: US 2015/0142165 A1
(43) Pub. Date: May 21, 2015

(54) UTILIZATION RATE CALCULATION METHOD AND SYSTEM THEREOF, EMBEDDED SYSTEM AND COMPUTER READABLE STORAGE MEDIUM

(71) Applicant: INSTITUTE FOR INFORMATION INDUSTRY, Taipei City (TW)

(72) Inventors: CHIH- CHIANG KAO, TAOYUAN COUNTY (TW); CHUN-TAI YEN, TAIPEI CITY (TW); CHIH-YI WU, YILAN COUNTY (TW); CHENG-HUNG PAN, TAIPEI CITY (TW)

(73) Assignee: INSTITUTE FOR INFORMATION INDUSTRY, Taipei City (TW)

(21) Appl. No.: 14/262,860

(22) Filed: Apr. 28, 2014

(30) Foreign Application Priority Data
Nov. 18, 2013 (TW) 102141876

(51) Int. Cl. G05B 19/05

(52) U.S. Cl. CPC G05B 19/054; G05B 2219/13058
USPC 700/174

(57) ABSTRACT

A utilization rate calculation method is disclosed. The utilization rate calculation method comprises steps as follows: scanning an operation signal of I/O ports via a I/O port capturing module; continuously receiving the operation signal via the I/O port capturing module; determining whether a machine tool is running according to the operation signal and a processing machine operation rule via a utilization rate calculation system; if the machine tool is running, recording a processing time data of the machine tool; generating a utilization rate according to the processing-time data and time data to be processed, wherein the processing-machine operation rule is a record for at least one I/O port stand for running corresponding to the machine tool which is running, and the I/O port stand for running is one of the I/O ports.

### BACKGROUND

1. Technical Field

The instant disclosure relates to a calculating technology for the utilization rate of the machine tool; in particular, to a utilization rate calculation method of the machine tool and the system thereof, the embedded device, and the computer-readable storage medium, in which the utilization rate calculation method can be implemented via the embedded device and the utilization rate calculation system.

2. Description of Related Art

The machine tool, especially the machine tool with the Computer Numerical control (CNC), has become a widely-used tool machine for manufacturing kinds of machines and equipments. Traditionally, before the workpiece is processed by the machine tool, it needs to load or edit a processing procedure for the machine tool to run and the operator can remotely control the machine tool. The operator would like to obtain the processing status and information of the machine tool via a remote platform, for example, whether the machine tool runs normally, whether there is an abnormal signal, the information about the processing procedure, the operator profile, the machine utilization rate and the like.

Briefly, the utilization rate is a ratio of the actual running time of the machine or equipment for workpiece to the uptime of the machine or equipment. That is, the utilization rate is a ratio of the loading time of the machine or equipment minus the down time to the loading time of the machine or equipment. The down time may be the total time for repairing, maintaining and none workpiece to be processed of the machine or equipment. Generally speaking, the higher the utilization rate is, the better the efficiency and performance of the machine or equipment shows. The utilization rate is generally calculated from the formula as below. Utilization rate=(Loading time−Down time)/(Loading time), wherein (Loading time−Down time) means the actual running time.

In the prior art, the working flow or working mechanism of most of machines or equipments are controlled by the Programmable Logic Controller (PLC). In order to have the utilization rate of each machine or equipment in the factory for further analyzing the performance and efficiency of each machine or equipment, traditionally it needs man-made efforts to have a report. In other words, the operator needs to scan the bar code of the workpiece to be processed and record it in the system before processing, or the operator needs to note the processing time of the machine or equipment via paper work before processing and then to record it manually in the system. However, the above ways to calculate the utilization rate via a man-made report are likely to result in an inaccuracy and thus cannot provide the utilization time of the machine or equipment.

### SUMMARY

The instant disclosure provides an automatic utilization rate calculation method, especially applied to the machine tool with PLC. The method and the system of the instant disclosure can be applied to various PLCs. Thus, there is no need to have an interface connection respectively for each kind of PLCs or machine tools according to different brands or types (for example, an interface connection via a hardware interface or a software interface). Further, the instant disclosure can automatically establish a rule corresponding to each kind of PLCs or machine tools respectively so as to use the rule to calculate the utilization rate for each of machine tools respectively.

The instant disclosure provides a utilization rate calculation method, used for calculating a utilization rate of a machine tool. The machine tool is connected to a programmable logic controller. The programmable logic controller is connected to an embedded device. The embedded device is connected to a utilization rate calculation system. The embedded device comprises an I/O port signal capturing module and a controller. The controller is connected to the I/O port signal capturing module to transmit an operation signal to the utilization rate calculation system so as to calculate the utilization rate. The utilization rate calculation system stores a machine tool operation rule and the programmable logic controller has a plurality of I/O ports. The utilization rate calculation method comprises steps as below: scanning the operation signal of the I/O port via the I/O port capturing module; receiving the operation signal continuously via the utilization rate calculation system; determining whether the machine tool is running according to the operation signal and the machine tool operation rule via the utilization rate calculation system; recording a running time data of the machine tool if the machine tool is running; and generating the utilization rate according to the running time data and a scheduled running time data. In particular, the machine tool operation rule is a record for at least one I/O port stand for running corresponding to the machine tool which is running, and the I/O port stand for running is one of the I/O ports.

In an embodiment of the instant disclosure, the machine tool operation rule is receiving the operation signal of the I/O ports corresponding to the running reference time according to the running reference time by the controller via a running reference time and an idle reference time set by the utilization rate calculation system; receiving operation signal of the I/O ports corresponding to the idle reference time according to the idle reference time by the controller; and further determining at least one I/O port stand for running according to the difference between the operation signal corresponding to the running reference time and the operation signal corresponding to the idle reference time. Particularly, the machine tool runs according to the running reference time and does not run according to the idle reference time.

In an embodiment of the instant disclosure, the machine tool operation rule is by the controller recording and transmitting the operation signal when the machine tool is running and the operation signal when the machine tool is not running to the utilization rate calculation system so as to determine at least a I/O port stand for running according to the difference between the operation signal recorded when the machine tool is running and the operation signal recorded when the machine tool is not running.

In an embodiment of the instant disclosure, the machine tool operation rule is that the I/O ports stand for running feature all output the operation signal, and that running time data is time accumulated when the I/O ports stand for running feature all have an output operation signal.

In an embodiment of the instant disclosure, the machine tool operation rule is comparing an output operation signal with a comparison operation signal of the I/O port stand for running within a time interval is compared and that the running time data is time accumulated when the output operation signal output by the I/O port stand for running coincides with the comparison operation signal.

In an embodiment of the instant disclosure, the utilization rate calculation system stores the machine tool operation rule via a database.

In an embodiment of the instant disclosure, the utilization rate calculation system is further used for connecting the machine tools via the embedded devices and used for determining whether one specific machine tool among the machine tools is registered. If the utilization rate calculation system determines that the specific machine tool has been registered, the controller corresponding to the specific machine tool scans the operation signal of the I/O port via the I/O port capturing module.

In an embodiment of the instant disclosure, the utilization rate calculation system further generates a utilization rate report according to the utilization rate generated.

The instant disclosure further provides an embedded device. The embedded device is connected to a utilization rate calculation system and a programmable logic controller of a machine tool, and used for calculating a utilization rate of the machine tool. The programmable logic controller has a plurality of I/O ports and the embedded device comprises an I/O port signal capturing module and a controller. The I/O port signal capturing module is used for scanning an operation signal of the I/O ports. The controller, connected to the I/O port capturing module, transmits the operation signal to the utilization rate calculation system so as to calculate the utilization rate. The utilization rate calculation system stores a machine tool operation rule, continuously receives the operation signal, determines whether the machine tool is running according the operation signal and the machine tool operation rule, and records a running time data of the machine tool. Afterwards, the utilization rate calculation system generates the utilization rate according to the running time data and a scheduled running time data. The machine tool operation rule is a record for at least one I/O port stand for running corresponding to the machine tool which is running, and the I/O port stand for running is one of the I/O ports.

The instant disclosure further provides another utilization rate calculation system, used for calculating a utilization rate of the machine tool via an embedded device connected to a programmable logic controller of a machine tool. The programmable logic controller has a plurality of I/O ports. The embedded device comprises an I/O port signal capturing module so as to scan an operation signal of the I/O ports and the embedded device also comprises a controller to transmit the operation signal to the utilization rate calculation system so as to calculate the utilization rate. The utilization rate calculation system comprises a storing unit, a determination unit and a calculation unit.

The instant disclosure further provides a computer-readable storage medium, used for storing a computer program. The computer program comprises a plurality of codes used for implementing a utilization rate calculation method used for calculating a utilization rate of a machine tool. The machine tool is connected to a programmable logic controller. The programmable logic controller is connected to an embedded device. The embedded device is connected to a utilization rate calculation system. The embedded device comprises an I/O port signal capturing module and a controller, and the controller is connected to the I/O port signal capturing module to transmit an operation signal to the utilization rate calculation system so as to calculate the utilization rate. The utilization rate calculation system stores a machine tool operation rule. The programmable logic controller has a plurality of I/O ports. The utilization rate calculation method comprises steps as below: scanning the operation signal of the I/O port via an I/O port signal capturing module of the embedded device; receiving the operation signal continuously via the utilization rate calculation system; determining whether the machine tool is running via the utilization rate calculation system according to the operation signal and the machine tool operation rule; if the machine tool is running, recording a running time data of the machine tool; and generating the utilization rate according to the running time data and a scheduled running time data. In particular, the machine tool operation rule is a record for at least one I/O port stand for running corresponding to the machine tool which is running, and the I/O port stand for running is one of the I/O ports.

To sum up, in the computer-readable storage medium, the embedded device, the utilization rate calculation system and the method thereof provided by the instant disclosure, via scanning each operation signal during the running reference time and the idle reference time, the I/O port stand for running is determined and the machine tool operation rule is generated. Afterwards, the operation signal of the I/O port stand for running is detected to determine whether the machine tool actually processes a workpiece under a processing procedure so as to calculate the utilization rate and generate the utilization rate report. Via the above, the equipment utilization rate of the machine tool is expected to be elevated.

For further understanding of the instant disclosure, reference is made to the following detailed description illustrating the embodiments and examples of the instant disclosure. The description is only for illustrating the instant disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a schematic block diagram of an embedded device according to an embodiment of the instant disclosure;

FIG. 2 shows a diagram of the waveforms of an operation signal according to an embodiment of the instant disclosure;

FIG. 3 shows a schematic diagram of a utilization rate calculation system according to an embodiment of the instant disclosure;

FIG. 4 shows a schematic diagram of a plurality of embedded devices according to an embodiment of the instant disclosure; and

FIG. 5 shows a flow chart of a utilization rate calculation method according to an embodiment of the instant disclosure.

### DETAILED DESCRIPTION OF EMBODIMENTS

Example embodiments will be described below in more detail with reference to the accompanying drawings. Many different forms and embodiments are possible without deviating from the spirit and teachings of this disclosure and so the disclosure should not be construed as limited to the embodiments set forth herein. Rather, these embodiments are provided so that this disclosure will be thorough and complete, and will fully convey the scope of the disclosure to those skilled in the art. In the drawings, the sizes and relative sizes of layers and regions may be exaggerated for clarity. Like reference numbers refer to like elements throughout.

It will be understood that, although the terms first, second, third, and the like, may be used herein to describe various elements, components, regions, layers and/or sections, these elements, components, regions, layers and/or sections should not be limited by these terms. These terms are only to distinguish one element, component, region, layer or section from another region, layer or section discussed below could be termed a second element, component, region, layer or section without departing from the teachings of the present disclosure. As used herein, the term “and/or” includes any and all combinations of one or more of the associated listed items.

The following instruction is to describe a utilization rate calculation method of the machine tool and the system thereof, the embedded device, and the computer-readable storage medium via a plurality of embodiments with corresponding drawings. However, the embodiments below are not for restricting the scope of the instant disclosure.

### The First Embodiment

In the instant disclosure, a machine tool operation rule can be established in advance for a specific machine tool, which determine at least one I/O port stand for running among a plurality of I/O ports of a programmable logic controller inside the specific machine tool so as to determine whether the machine tool is processing a workpiece under a processing procedure. In one embodiment, the specific machine tool can be registered (or verified) in the utilization rate calculation system. Accordingly, when the specific machine tool has been registered or verified, the utilization rate calculation system can identify the specific machine tool and obtain the processing feature I/O port, the loading time of the specific machine tool and other information. After that, the utilization rate calculation system determines whether the machine tool is actually processing a workpiece under the processing procedure according to an operation signal of the processing feature I/O port. The utilization rate calculation system records the actual processing time when the specific machine tool is running under the processing procedure. The utilization rate calculation system can automatically calculate a utilization rate according to the actual processing time and the loading time, and then generate a utilization rate report so as to detect and control the equipment utilization rate of the machine tool.

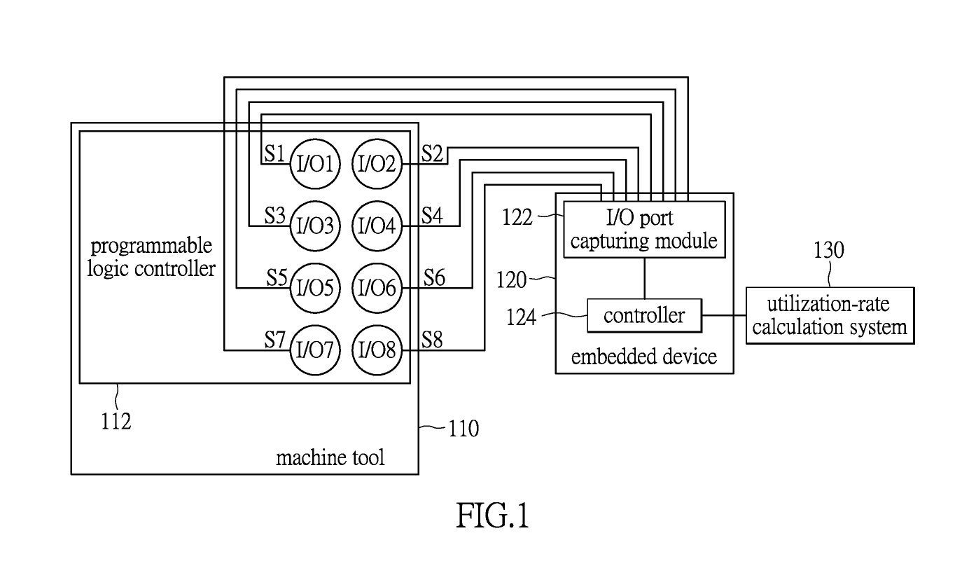

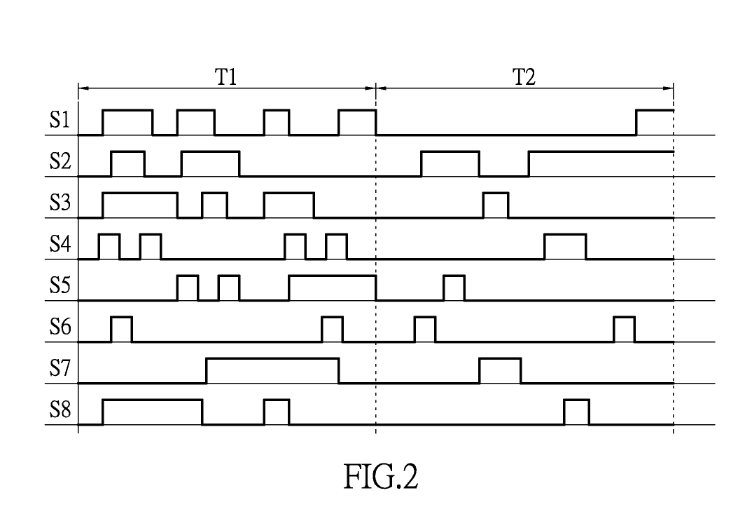

In conjunction with FIGS. 1 and 2, FIG. 1 shows a schematic block diagram of an embedded device according to an embodiment of the instant disclosure, and FIG. 2 shows a diagram of the waveforms of an operation signal according to an embodiment of the instant disclosure. The connection mentioned in the following embodiments may be via a wired communication net or a wireless communication net, and also may be via a bus bar, a sequence data communication interface such as RS232, or other physical circuits to have an electrical connection. As shown in FIG. 1, an embedded device 120 is electrically connected to a utilization rate calculation system 130 and a programmable logic controller 112 of a machine tool 110. The programmable logic controller 112 has a plurality of I/O ports I/O1˜I/O8. In the present embodiment, the embedded device 120 comprises an I/O port signal capturing module 122 and a controller 124. The controller 124 is electrically connected to the I/O port signal capturing module 122 to receive and transmit at least one operation signal among the operation signals S1˜S8 to the utilization rate calculation system 130 so as to generate the utilization rate information. Afterwards, the utilization rate calculation system 130 further generates a utilization rate report according to the utilization rate information.

In the present embodiment, the embedded device 120 scans each operation signal of I/O ports I/O1˜I/O8 via the I/O port signal capturing module 122 during a running reference time T1, and the controller 124 receives and transmits each of the operation signals S1˜S8 to the utilization rate calculation system 130. Moreover, the embedded device 120 scans each operation signal of I/O ports I/O1˜I/O8 via the I/O port signal capturing module 122 during an idle reference time T2, and the controller 124 receives and transmit each of the operation signals S1˜S8 to the utilization rate calculation system 130. The utilization rate calculation system 130 stores the machine tool operation rule via a database or a storing unit.

To be more specific, the machine tool operation rule can be generated in kinds of ways. For example, a running reference time T1 and an idle reference time T2 can be set in the utilization rate calculation system 130. The machine tool 110 runs during the running reference time T1 and stop during the idle reference time T2 (that is, the machine tool does not run in the idle reference time T2). The running reference time T1 and the idle reference time T2 are both time intervals. For example, the running reference time T1 is from 11:00 to 11:20 and the idle reference time T2 is from 11:20 to 11:40. The controller 124 receives operation signals S1˜S8 of the I/O ports I/O1˜I/O8 corresponding to the running reference time T1, and receives operation signals S1˜S8 of the I/O ports I/O1˜I/O8 corresponding to the idle reference time T2. In one embodiment, the controller 124 may continuously receive operation signals S1˜S8 and capture operation signals S1˜S8 corresponding to the running reference time T1 and the idle reference time T2 according to the running reference time T1 and the idle reference time T2 via the utilization rate calculation system 130. Afterwards, the utilization rate calculation system 130 determines at least one I/O port stand for running according to the difference between the operation signals S1˜S8 corresponding to the running reference time T1 and the operation signals S1˜S8 corresponding to the idle reference time T2. For example, in one embodiment, according to the I/O ports I/O1˜I/O4 having operation signals during the running reference time T1 and the I/O ports I/O1˜I/O2 having operation signals during the idle reference time T2, it can be determined that the I/O ports stand for running feature are the I/O ports I/O3˜I/O4. In another embodiment, the running reference time T1 may be divided into a plurality of time intervals, and the operation signal during each time interval may be different. Thus, in this situation, the longer time intervals may be chosen first and the I/O port having operation signal during all of these time intervals is determined as the I/O port having operation signal during the running reference time T1. Likewise, the I/O port having operation signal during the idle reference time T2 can be determined in the same way. It is worth noticing that, the machine tool operation rule of the present embodiment is that the I/O ports stand for running feature all output the operation signal and the running time data is time accumulated when the I/O ports stand for running feature all have an output operation signal. Therefore, in the present embodiment, the utilization rate calculation system 130 can obtain the information about whether the machine tool is running via the operation signals of the I/O ports stand for running feature. In other words, the machine tool operation rule is a record for at least one I/O port stand for running corresponding to the machine tool which is running, and the I/O port stand for running is one of the I/O ports.

For example, as shown in FIG. 2, the embedded device 120 scans during the running reference time T1 and the idle reference time T2 respectively to know whether the I/O ports I/O1˜I/O8 output operation signals, which may be at least one of the operation signals S1˜S8, and the controller 124 transmits the outputted operation signals to the utilization rate calculation system 130. After that, the utilization rate calculation system 130 determines the I/O ports I/O3 and I/O6 as the I/O ports stand for running feature according to the difference between the operation signal corresponding to the running reference time T1 and the operation signal corresponding to the idle reference time T2. At this time, the utilization rate calculation system 130 records the I/O port I/O3 and the I/O port I/O6, and the machine tool operation rule is that the I/O ports stand for running feature, such as the I/O port I/O3 and the I/O port I/O6, both output the operation signal, S3 and S6, and the running time data is time when the I/O ports I/O3 and I/O6 both have an output operation signal. After that, the utilization rate calculation system 130 stores the I/O ports stand for running feature as the machine tool operation rule, and the embedded device 120 scans continuously and transmits the operation signals of the I/O ports I/O1˜I/O8 to the utilization rate calculation system 130. The utilization rate calculation system 130 continuously receives at least one of the operation signals S1˜S8 and compares the received signal with the machine tool operation rule so as to determine whether the machine tool 110 is processing a workpiece under the processing procedure. In other words, the machine tool operation rule is that “the I/O ports stand for running feature are I/O ports I/O3 and I/O6, and when the utilization rate calculation system 130 continuously receives the operation signals S3 of the I/O port stand for running I/O3 and S6 of the I/O port stand for running I/O6, it can be determined that the machine tool 110 is processing a workpiece under the processing procedure.” In another embodiment, the machine tool operation rule is comparing an output operation signal with the comparison operation signal of the I/O port stand for running in a time interval, and that the running time data is time accumulated when the I/O port stand for running outputs the output operation signal which coincides with the comparison operation signal of the processing feature I/O port. If the utilization rate calculation system 130 determines that the machine tool 110 is processing a workpiece under the processing procedure, the utilization rate calculation system 130 records a running time data of the machine tool 110 and generates a utilization rate according to the running time data (that is, the actual processing time) and the scheduled running time data (that is, the loading time). Accordingly, the instant disclosure can actually show the utilization time of the machine tool and automatically generate a utilization rate report so as to effectively reduce the production cost and increase the equipment utilization rate of the machine tool. In addition, the instant disclosure can calculate for all machine tools with PLC, has extensibility and is capable of automatically establishing rules for different kinds of machine tools.

In another embodiment, the machine tool operation rule stored in the utilization rate calculation system 130 is the operation signal recorded by the controller 124 of the embedded device 120 when the machine tool is running and the operation signal when the machine tool is not running, and transmitting each operation signal to the utilization rate calculation system 130 so as to determine at least one I/O port stand for running according to the difference between the operation signal recorded when the machine tool 110 should run and the operation signal when the machine tool 110 is not running. Afterwards, the operation signal output from the I/O port stand for running is used as a standard for determining whether the machine tool 110 is processing a workpiece.

For a specific instruction on an operation process of the utilization rate calculation method the machine tool of the instant disclosure, there is at least one of the embodiments for a further instruction.

In the following embodiments, there are only parts different from embodiments in FIG. 1 described, and the omitted parts are indicated to be identical to the embodiments in FIG. 1. In addition, for an easy instruction, similar reference numbers or symbols refer to elements alike.

### The Second Embodiment

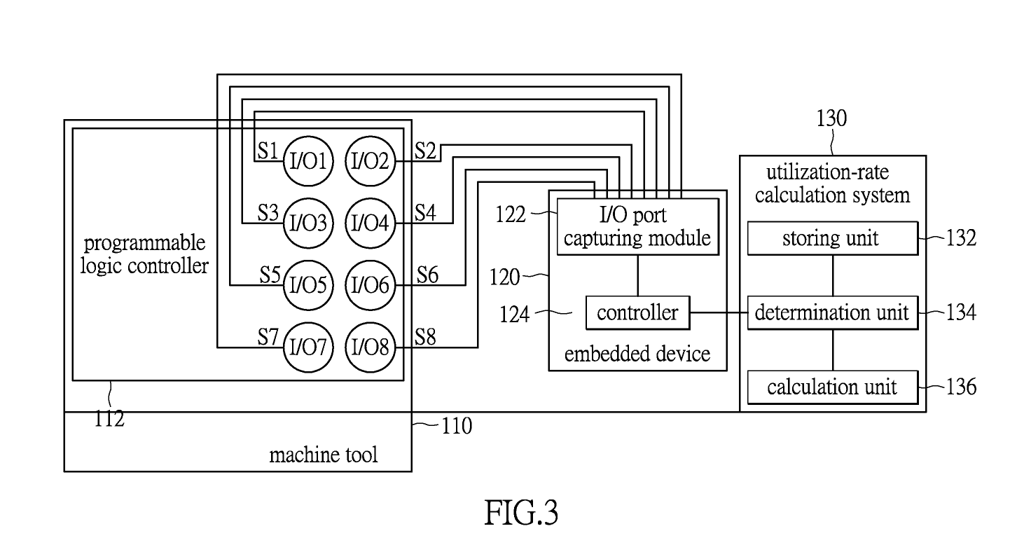

In conjunction with FIGS. 2 and 3, FIG. 3 shows a schematic diagram of a utilization rate calculation system according to an embodiment of the instant disclosure. The utilization rate calculation system 130 is connected to the programmable logic controller 112 of the machine tool 110 via the embedded device 120, and the utilization rate calculation system 130 is used for calculating the utilization rate of the machine tool 110. The programmable logic controller 112 has a plurality of I/O ports I/O1˜I/O8. The embedded device 120 comprises an I/O port signal capturing module 122 to scan and determine whether the I/O ports I/O1˜I/O8 output operation signals, which at least may be one of the operation signals S1˜S8. The controller 124 is used for transmitting the operation signal to the utilization rate calculation system 130 so as to calculate the utilization rate. In the present embodiment, the utilization rate calculation system 130 comprises a storing unit 132, a determination unit 134 and a calculation unit 136. The determination unit 134 is connected to the storing unit 132, and the calculation unit 136 is connected to the determination unit 134. The storing unit 132 is used for storing the machine tool operation rule and the machine tool operation rule is recording at least one I/O port stand for running corresponding to the time when the machine tool is running and that the I/O port stand for running is one of the I/O ports. The determination unit 134 is used for continuously receiving operation signals and determining whether the machine tool 110 is processing a workpiece under the processing procedure according to the operation signals and the machine tool operation rule, and used for recording a running time data of the machine tool 110. The calculation unit 136 is used for generating a utilization rate according to the running time data and the scheduled running time data.

Likewise, in the present embodiment, the embedded device 120 scans each of the operation signals S1˜S8 of the I/O ports I/O1˜I/O8 via the I/O port signal capturing module 122 during the running reference time T1, and the controller 124 receives and transmits each of the operation signals S1˜S8 to the determination unit 134. Besides, the embedded device 120 scans each of the operation signals S1˜S8 of the I/O ports I/O1˜I/O8 via the I/O port signal capturing module 122 during the idle reference time T2, and the controller 124 receives and transmits each operation signal to the determination unit 134 so as to generate the machine tool operation rule. The rest of the work mechanism is identical to the embodiment in FIG. 1 recited above, and it is not repeated thereto.

### The Third Embodiment

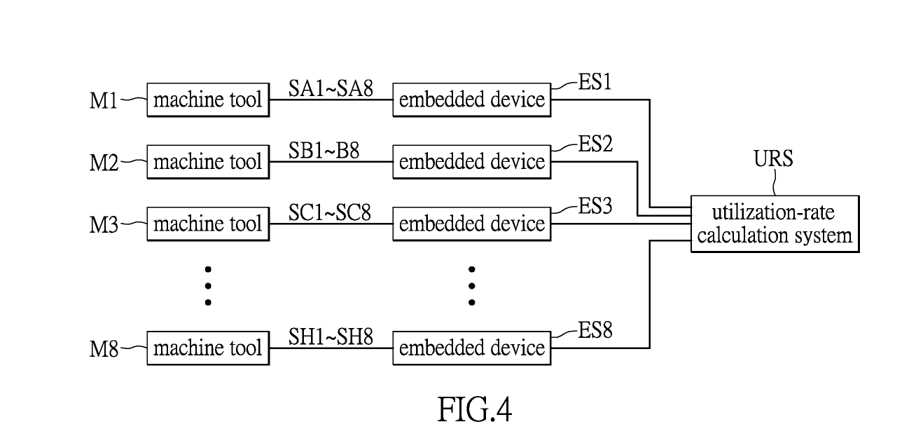

Please refer to FIG. 4, FIG. 4 shows a schematic diagram of a plurality of embedded devices according to an embodiment of the instant disclosure. For an easy instruction and understanding of the instant disclosure, the present embodiment takes eight embedded devices for an example, and it is not limited thereto. A plurality of embedded devices ES1˜ES8 are respectively connected to a plurality of machine tools M1˜M8, and the embedded devices ES1˜ES8 are connected to the utilization rate calculation system URS. In the present embodiment, the utilization rate calculation system URS first determines whether a specific machine tool among the machine tools M1˜M8, such as the machine tool M5, is registered (or verified). When the utilization rate calculation system URS determines the specific machine tool, such as the machine tool M5, has been registered, the operating status of the I/O port of the specific machine tool, such as the machine tool M5, is scanned via the I/O port signal capturing module by the controller inside the corresponding embedded device, such as the embedded device ES5, of the specific machine tool, such as the machine tool M5. Furthermore, each machine tool shown in FIG. 4 is the same as the machine tool 110 in the embodiment shown in FIG. 1, and each embedded device shown in FIG. 4 may be the embedded device 120 in the embodiment shown in FIG. 1. Therefore, when the machine tool M5 is going to process a workpiece under the processing procedure, the utilization rate calculation system URS first determines whether the machine tool M5 has been registered. If the machine tool M5 has been registered or verified, the machine tool M5, the embedded device ES5 and the utilization rate calculation system URS start the working mechanism in the embodiment shown in FIG. 1, and there is no need to go into details. In the present embodiment, the utilization rate calculation system URS may be the utilization rate calculation system 130 in the embodiment shown in FIG. 1 or the utilization rate calculation system 130 in the embodiment shown in FIG. 3.

### The Fourth Embodiment

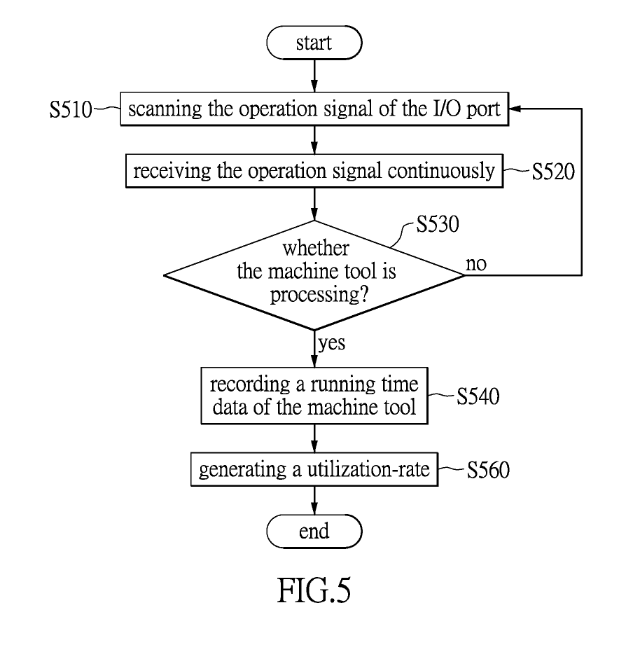

In conjunction with FIGS. 1 and 5, FIG. 5 shows a flow chart of a utilization rate calculation method according to an embodiment of the instant disclosure. The utilization rate calculation method is used for calculating the utilization rate of the machine tool 110. The machine tool 110 is connected to the programmable logic controller 112. The programmable logic controller 112 is connected to the embedded device 120. The embedded device 120 is connected to the utilization rate calculation system 130. The embedded device 120 comprises the I/O port signal capturing module 122 and the controller 124. The controller 124 is connected to the I/O port signal capturing module 122 to transmit the operation signal to the utilization rate calculation system 130 so as to calculate the utilization rate. The utilization rate calculation system stores a machine tool operation rule. The programmable logic controller 112 has a plurality of I/O ports I/O1˜I/O8. The utilization rate calculation method comprises steps as below: scanning the operation signal of the I/O port via an I/O port signal capturing module of the embedded device (the step S510); receiving the operation signal continuously via the utilization rate calculation system (the step S520); determining whether the machine tool is running via the utilization rate calculation system according to the operation signal and the machine tool operation rule (the step S530); if the machine tool is running, recording a running time data of the machine tool (the step S540); and generating the utilization rate according to the running time data and a scheduled running time data, in which the machine tool operation rule is a record for at least one I/O port stand for running corresponding to the machine tool which is running and the I/O port stand for running is one of the I/O ports (the step S560). After that, in the following description is further instruction in teaching each step of the utilization rate calculation method, in order to make the instant disclosure well understood.

The step S510: the embedded device scans the operation signal of the I/O port. That is, the controller of the embedded device corresponding to the specific machine tool scans the operating status of the I/O port of the specific machine tool via the I/O port capturing module. Furthermore, the controller, according to the running reference time, receives the operation signals of the I/O ports corresponding to the running reference time, and the controller, according to the idle reference time, receives the operation signals of the I/O ports corresponding to the idle reference time. Afterwards, the utilization rate calculation system determines at least one I/O port stand for running according to the difference between the signals corresponding to the running reference time and the signals corresponding to the idle reference time.

The step S520: continuously receiving the operation signals by the utilization rate calculation system. That is, the utilization rate calculation system continuously receives at least one of the operation signals, which is the operation signal of the processing feature I/O port.

The step S530: determining whether the machine tool is running by the utilization rate calculation system. That is, the utilization rate calculation system makes a comparison according to the received operation signal of the I/O port stand for running and the machine tool operation rule so as to determine whether the machine tool is running. Moreover, the machine tool operation rule is that the I/O ports stand for running feature all output the operation signals and that the running time data is time accumulated when the I/O ports stand for running feature all output the operation signals. In addition, the machine tool operation rule is comparing the output operation signal with the comparison operation signal of the I/O port stand for running in a time interval, and that the running time data is time accumulated when the I/O port stand for running outputs the operation signal and the output operation signal coincides with the comparison operation signal of the processing feature I/O port.

The step S540: recording the running time data of the machine tool by the utilization rate calculation system. That is, if the machine tool is processing a workpiece, the utilization rate calculation system records the running time data of the machine tool.

The step S560: generating the utilization rate by the utilization rate calculation system. That is, the utilization rate calculation system calculates and generates the utilization rate according to the running time data and the loading data. In some embodiments, the utilization rate can be obtained according to actual processing time of the machine tool divided by the loading time per day, per week, per month or per year. Generally speaking, the loading time is the maximum time when a machine tool is operable per day, per week or per month, which can be known from the manufacturer.

For a further instruction, in some specific embodiments, between the step S540 and the step S560, there could be a step S550 added (not shown). The step S550: determining whether to continuously receive the operation signal of the I/O port by the utilization rate calculation system. That is, the utilization rate calculation system determines whether the I/O port inside the embedded device continuously receives the operation signal of the programmable logic controller. If yes, it turns back to the step S510 so as to scan the operation signal of the I/O port; if no, it proceeds to the step S560.

For a further instruction, in other specific embodiments, the utilization rate calculation system can be linked with a plurality of machine tools and their corresponding embedded devices. Therefore, before the step S510, there can be a step S505 added (not shown). The step S505: determining whether one specific machine tool of a plurality of machine tools is registered by the utilization rate calculation system. When the utilization rate calculation system determines that the specific machine tool is registered, it proceeds to the step S510 and the corresponding embedded device of the specific machine tool scans the operation signal of the I/O port corresponding to the specific machine tool. When the utilization rate calculation system determines that the specific machine tool is not yet registered, it proceeds to another register step to require the specific machine tool to be registered and then it proceeds to the step S510 after the specific machine tool is registered.

Relevant details of the steps of the utilization rate calculation method are described in the embodiments of FIGS. 1-4, and thus it is not repeated thereto. It is clarified that, a sequence of steps in FIG. 5 is set for a need to instruct easily, and thus the sequence of the steps is not used as a condition in demonstrating the embodiments of the instant disclosure.

### The Fifth Embodiment

The instant disclosure provides a computer-readable storage medium. The computer-readable storage medium is used for storing a computer program, and the computer program comprises a plurality of codes. In one embodiment, the computer program is loaded into the embedded device, or in another embodiment, the computer program is loaded into the utilization rate calculation system. The computer program is used for implementing a utilization rate calculation method for calculating a utilization rate of a machine tool. The machine tool is connected to the programmable logic controller. The programmable logic controller is connected to the embedded device. The embedded device is connected to the utilization rate calculation system. The embedded device comprises an I/O port signal capturing module and a controller. The controller is connected to the I/O port signal capturing module to transmit the operation signal to the utilization rate calculation system so as to calculate the utilization rate. The utilization rate calculation system stores the machine tool operation rule, and the programmable logic controller has a plurality of I/O ports. The utilization rate calculation method comprises steps as follows: scanning the operation signal of the I/O port via an I/O port signal capturing module of the embedded device; receiving the operation signal continuously via the utilization rate calculation system; determining whether the machine tool is running via the utilization rate calculation system according to the operation signal and the machine tool operation rule; if the machine tool is running, recording the running time data of the machine tool; and generating a utilization rate according to the running time data and the scheduled running time data. The machine tool operation rule is a record for at least one I/O port stand for running corresponding to the machine tool which is running, and the I/O port stand for running is one of the I/O ports

To sum up, via the computer-readable storage medium, the embedded device, the utilization rate calculation system and the method thereof, a user can first establish a machine tool operation rule so as to determine at least one I/O port stand for running among a plurality of I/O ports of the programmable logic controller inside the specific machine tool to become a standard for whether the machine tool is processing a workpiece. Accordingly, whether the machine tool is actually processing a workpiece is determined via detecting the operation signal of the processing feature I/O port, and further a utilization rate is calculated and a utilization rate report is generated. The instant disclosure can actually show the utilization time of the machine tool and automatically generate a utilization rate report so as to effectively reduce the production cost and increase the equipment utilization rate of the machine tool. The instant disclosure can calculate for the machine tools with PLC, has extensibility and is capable of automatically establishing rules for different kinds of machine tools.

The invention can be implemented in any suitable form including hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A utilization rate calculation method, used for calculating a utilization rate of a machine tool, the machine tool connected to a programmable logic controller, the programmable logic controller connected to an embedded device, the embedded device connected to a utilization rate calculation system, the embedded device comprising an I/O port signal capturing module and a controller, the controller connected to the I/O port signal capturing module to transmit an operation signal to the utilization rate calculation system so as to calculate the utilization rate, wherein the utilization rate calculation system stores a machine tool operation rule, the programmable logic controller has a plurality of I/O ports, and the utilization rate calculation method comprises the following steps of:
scanning the operation signal of the I/O port via the I/O port capturing module;
receiving the operation signal continuously via the utilization rate calculation system;
determining whether the machine tool is running according to the operation signal and the machine tool operation rule via the utilization rate calculation system;
recording a running time data of the machine tool if the machine tool is running; and
generating the utilization rate according to the running time data and a scheduled running time data;
wherein the machine tool operation rule is a record for at least one I/O port stand for running corresponding to the processing machine which is running, and the I/O port stand for running is one of the I/O ports.

2. The utilization rate calculation method according to claim 1, wherein the machine tool operation rule is generated by the following steps of:
setting a running reference time and an idle reference time by the utilization rate calculation system;
receiving the operation signal of the I/O ports corresponding to the running reference time according to the running reference time by the controller;
receiving operation signal of the I/O ports corresponding to the idle reference time according to the idle reference time by the controller; and
determining at least one I/O port stand for running according to a difference between the operation signal corresponding to the running reference time and the operation signal corresponding to the idle reference time,
wherein the machine tool runs according to the running reference time and does not run according to the idle reference time.

3. The utilization rate calculation method according to claim 1, wherein the machine tool operation rule is generated by the following steps of:
recording the operation signal when the machine tool is running and the operation signal when the machine tool is not running by the controller; and
transmitting the operation signal to the utilization rate calculation system so as to determine at least one I/O port stand for running according to the difference between the operation signal recorded when running and the operation signal recorded when not running.

4. The utilization rate calculation method according to claim 1, wherein the machine tool operation rule is recorded all the I/O ports stand for running feature which output to the operation signal when the machine tool is running and that the running time data is time accumulated when the I/O ports stand for running feature all output the operation signal.

5. The utilization rate calculation method according to claim 1, wherein the machine tool operation rule is recorded to compare an output operation signal with a comparison operation signal of the I/O port stand for running within a time interval, and the running time data is time accumulated when the output operation signal output by the I/O port stand for running coincides with the comparison operation signal.

6. The utilization rate calculation method according to claim 1, wherein the utilization rate calculation system stores the machine tool operation rule via a database.

7. The utilization rate calculation method according to claim 6, wherein the utilization rate calculation system is further used for connecting the machine tools via the embedded devices and used for determining whether one specific machine tool among the machine tools is registered, and if the utilization rate calculation system determines that the specific machine tool has been registered, the controller corresponding to the specific machine tool scans the operation signal of the I/O port via the I/O port capturing module.

8. The utilization rate calculation method according to claim 1, wherein the utilization rate calculation system further generates a utilization rate report according to the utilization rate generated.

9. An embedded device, connected to a utilization rate calculation system and a programmable logic controller of a machine tool, used for calculating a utilization rate of the machine tool, wherein the programmable logic controller has a plurality of I/O ports, the embedded device comprising:
an I/O port capturing module, used for scanning an operation signal of the I/O ports; and
a controller, connected to the I/O port capturing module, transmitting the operation signal to the utilization rate calculation system so as to calculate the utilization rate;
wherein the utilization rate calculation system stores a processing machine operation rule, continuously receives the operation signal, determines whether the machine tool is running according the operation signal and the machine tool operation rule and records a running time data of the machine tool, and generates the utilization rate according to the running time data and a scheduled running time data, the machine tool operation rule is a record for at least one I/O port stand for running corresponding to the machine tool which is running, and the I/O port stand for running is one of the I/O ports.

10. The embedded device according to claim 9, wherein the machine tool operation rule is receiving the operation signal of the I/O ports corresponding to the running reference time according to the running reference time by the controller, and receiving operation signal of the I/O ports corresponding to the idle reference time according to the idle reference time by the controller via a running reference time and an idle reference time set by the utilization rate calculation system and further determining at least one I/O port stand for running according to a difference between the operation signal corresponding to the running reference time and the operation signal corresponding to the idle reference time, wherein the machine tool runs according to the running reference time and does not run according to the idle reference time.

11. The embedded device according to claim 9, wherein the machine tool operation rule comprises is recording and transmitting the operation signal when the machine tool is running and the operation signal when the machine tool is not running by the controller to the utilization rate calculation system so as to determine at least one I/O port stand for running according to the difference between the operation signal recorded when the machine tool is running and the operation signal recorded when the machine tool is not running.

12. The embedded device according to claim 9, wherein the machine tool operation rule is that the I/O ports stand for running feature all have the operation signal and the running time data is time accumulated when the I/O ports stand for running feature all output the operation signal.

13. The embedded device according to claim 9, wherein the machine tool operation rule is comparing an output operation signal with a comparison operation signal of the I/O port stand for running within a time interval and the running time data is time accumulated when the output operation signal output by the I/O port stand for running coincides with the comparison operation signal.

14. The embedded device according to claim 9, wherein the utilization rate calculation system stores the machine tool operation rule via a database.

15. The embedded device according to claim 14, wherein the utilization rate calculation system is further used for connecting the machine tools via the embedded devices and used for determining whether one specific machine tool among the machine tools is registered, and if the utilization rate calculation system determines that the specific machine tool has been registered, the controller corresponding to the specific machine tool scans the operation signal of the I/O port via the I/O port capturing module.

16. The embedded device according to claim 9, wherein the utilization rate calculation system further generates a utilization rate report according to the utilization rate generated.

17. A utilization rate calculation system, used for calculating a utilization rate of the machine tool via an embedded device connected to a programmable logic controller of a machine tool, wherein the programmable logic controller has a plurality of I/O ports, the embedded device comprises an I/O port signal capturing module so as to scan an operation signal of the I/O ports and a controller to transmit the operation signal to the utilization rate calculation system so as to calculate the utilization rate, the utilization rate calculation system comprising:
a storing unit, storing a machine tool operation rule, wherein the machine tool operation rule comprises is a record for at least one I/O port stand for running corresponding to the machine tool which is running, and the processing feature I/O port is one of the I/O ports;
a determination unit, receiving the operation signal continuously, determining whether the machine tool is running according the operation signal and the machine tool operation rule and recording a running time data of the machine tool; and
a calculation unit generating the utilization rate according to the running time data and a scheduled running time data.

18. A computer readable storage medium, used for storing a computer program, the computer program comprising a plurality of codes used for implementing a utilization rate calculation method used for calculating a utilization rate of a machine tool, wherein the machine tool is connected to a programmable logic controller, the programmable logic controller is connected to an embedded device, the embedded device is connected to a utilization rate calculation system, the embedded device comprises an I/O port signal capturing module and a controller, and the controller is connected to the I/O port signal capturing module to transmit an operation signal to the utilization rate calculation system so as to calculate the utilization rate, wherein the utilization rate calculation system stores a machine tool operation rule, the programmable logic controller has a plurality of I/O ports, the utilization rate calculation method comprising steps as below:
scanning the operation signal of the I/O port via an I/O port capturing module of the embedded device;
receiving the operation signal continuously via the utilization rate calculation system;
determining whether the machine tool is running via the utilization rate calculation system according to the operation signal and the machine tool operation rule;
if the machine tool is running, recording a running time data of the processing machine; and
generating the utilization rate according to the running time data and a scheduled running time data;
wherein the machine tool operation rule is a record for at least one I/O port stand for running corresponding to the processing machine which is running, and the I/O port stand for running is one of the I/O ports.
